(19) United States
(12) Patent Application Publication
(10) Pub. No.: US 2016/0055492 A1
(43) Pub. Date: Feb. 25, 2016

(54) SYSTEM AND METHOD FOR TRACKING CUSTOMERS IN PREDETERMINED LOCATIONS

(71) Applicant: Jeffrey FIDELMAN, New York, NY (US)

(72) Inventor: Jeffrey FIDELMAN, New York, NY (US)

(21) Appl. No.: 14/831,944

(22) Filed: Aug. 21, 2015

Related U.S. Application Data
(60) Provisional application No. 62/040,161, filed on Aug. 21, 2014.

(51) Int. Cl. G06Q 30/02; G06K 9/00; G06T 11/20

(52) U.S. Cl. CPC G06Q 30/0201; G06T 11/20; G06K 9/00476

(57) ABSTRACT

A system for tracking patrons within a predetermined space is provided. The system includes a controller and at least one wifi router selectively positioned around the predetermined space. Each router can communicate with patron-held wifi devices within its range of coverage. The controller can then determine the route taken by each wifi device-carrying patron throughout the predetermined space based on the identity of each router that communicated with the associated wifi device and the times of those communications.

### CROSS-REFERENCE TO RELATED APPLICATION

This application claims the benefit of priority of U.S. provisional application No. 62/040,161, filed 21 Aug. 2014, the contents of which are herein incorporated by reference.

### BACKGROUND OF THE INVENTION

Customer information has become a valuable commodity in the digital age, with social media companies, retailers, search engines, and others all vying for the largest consumer database. Although tracking consumer behavior on the internet is common practice, it has been more difficult to apply this concept to the physical world of brick and mortar retailers.

Store owners, building owners, and other proprietors of predetermined spaces have not been able to track their patrons and/or efficiently market directly to them. Current customer tracking systems require a sign in, login or sign up, where the customer must input all of his/her information. Moreover, current systems do not have the ability to track the location of a connected smartphone through a given space. There remains a need for a way to track customers in brick and mortar retail locations and the like without requiring customer effort. This system should also be able to track customer behavior in the predetermined spaces with a high degree of specificity.

### SUMMARY OF THE INVENTION

In one aspect of the present invention, a system for tracking consumers in a predetermined space includes a controller; at least one wifi router selectively positioned around the predetermined space, with each wifi router in communication with the said controller; and at least one wifi device carried by a consumer, wherein each wifi router is adapted to communicate with at least one wifi device, and wherein the controller is configured to determine a route through the predetermined space taken by at least one wifi device from the identity of each router that communicated with at least one wifi device and the times of those communications.

In another aspect of the present invention, a method of tracking consumers within a predetermined space includes providing a controller in communication to a plurality of wifi routers; selectively placing the plurality of wifi routers throughout the predetermined space; configuring the plurality of wifi routers to passively communicate with wifi devices occupying the predetermined space, wherein each wifi device is carried by a consumer, and configuring the controller to determine a route travelled, and the time spent by each wifi device based in part on identifying each router that communicated with each wifi device, and the times of those communications.

These and other features, aspects, and advantages of the present invention will become better understood with reference to the following drawings, description, and claims.

### BRIEF DESCRIPTION OF THE DRAWINGS

FIG. 1 is a diagram of the system according to an exemplary embodiment of the present invention;

FIG. 2 is a diagram of the system according to an exemplary embodiment of the present invention;

FIG. 3 is a diagram of the system according to an exemplary embodiment of the present invention shown in FIG. 1, shown installed in a movie theater;

FIG. 4 is a diagram of the system according to an exemplary embodiment of the present invention shown in FIG. 1, shown installed in an apartment;

FIG. 5 is an output graph of the total attendance generated by the system according to the embodiment shown in FIG. 1;

FIG. 6 is an output graph of the conversion rate generated by the system according to the embodiment shown in FIG. 1;

FIG. 7 is an output graph of the returning customers generated by the system according to the embodiment shown in FIG. 1;

FIG. 8 is an output graph of the visit time generated by the system according to the embodiment shown in FIG. 1;

FIG. 9 is an output graph of the attendance vs. time generated by the system according to the embodiment shown in FIG. 1; and

FIG. 10 is an output graph of the visit frequency generated by the system according to the embodiment shown in FIG. 1.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a system for tracking patrons within a predetermined space that includes a controller and at least one wifi router selectively positioned around the predetermined space. Each router can communicate with patron-held wifi devices within its range of coverage. The controller can then determine the route taken by each wifi device-carrying patron throughout the predetermined space, based on the identity of each router that communicated with an associated wifi device and the times of those communications.

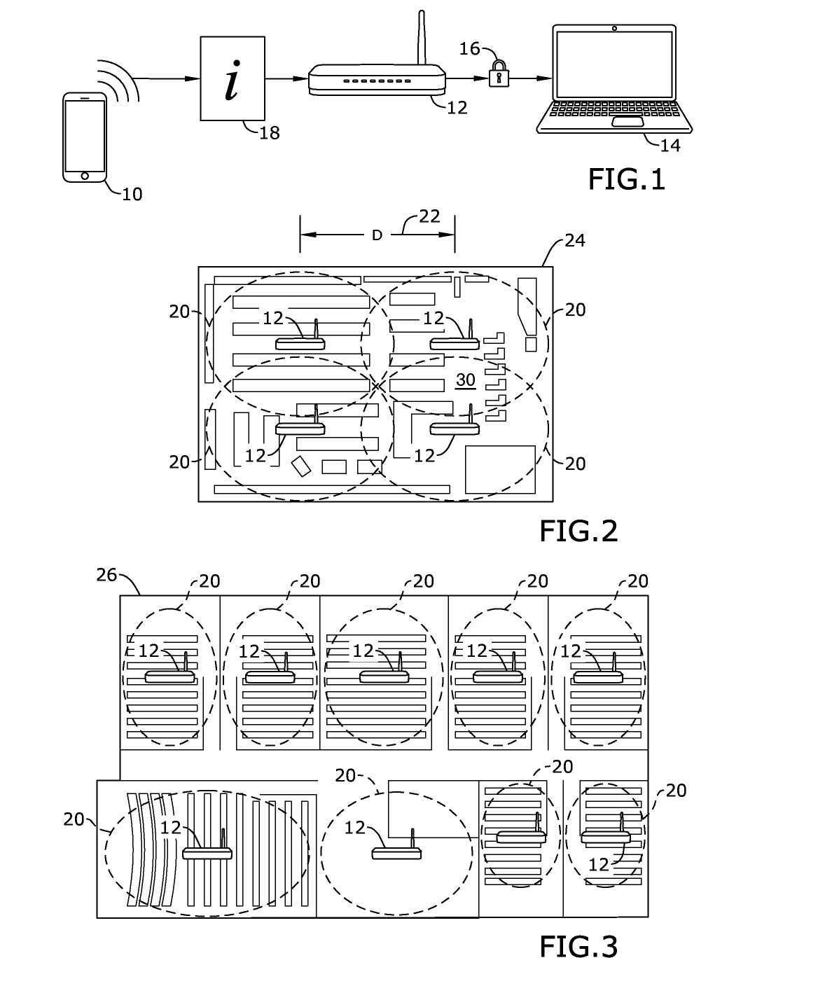

Referring to FIGS. 1 through 10, the present invention may include at least one controller 14 with a user interface. The controller 14 may include any computer having at least one processing unit and a form of memory including, but not limited to, a desktop, laptop, and smart device, such as, a tablet and/or smart phone. The computer may include a program product including a machine-readable program code for causing, when executed, the computer to perform steps. The program product may include software which may either be loaded onto the computer or accessed by the computer. The loaded software may include an application on a smart device. The software may be accessed by the computer using a web browser. The computer may access the software via the web browser using the internet, extranet, intranet, host server, internet cloud, and the like.

FIG. 1 is a diagram of the system according to one embodiment. The system includes at least one wifi device 10 such as a smartphone, smart-watch, laptop, tablet, and the like carried by a customer. Each wifi device 10 may communicate with at least one router 12 connected to the system that has a secure connection 16 to a controller (a laptop in this embodiment) 14. The controller 14 will use at least one router 12 to collect customer information 18 from at least one wifi device 10 about the customer or visitor (including but not limited to as MAC address, the type of phone, and the customer's activities and location), whereby the consumer information 18 may be indicative of personal preferences of the customer carrying the wifi device.

In several embodiments, off-the-shelf wifi routers 12 are retrofitted in order to work with this system. A custom script is created and installed in the OEM wifi routers. This script enables passive connection and location tracking, phone information, and MAC address capture. The routers 12 are then installed in the predetermined space. In certain embodiments, the routers 12 are installed approximately 50 feet apart from each other. After the controller 14 collects data from the routers 12, analytics can be performed on the data and presented to the retailer or other interested parties.

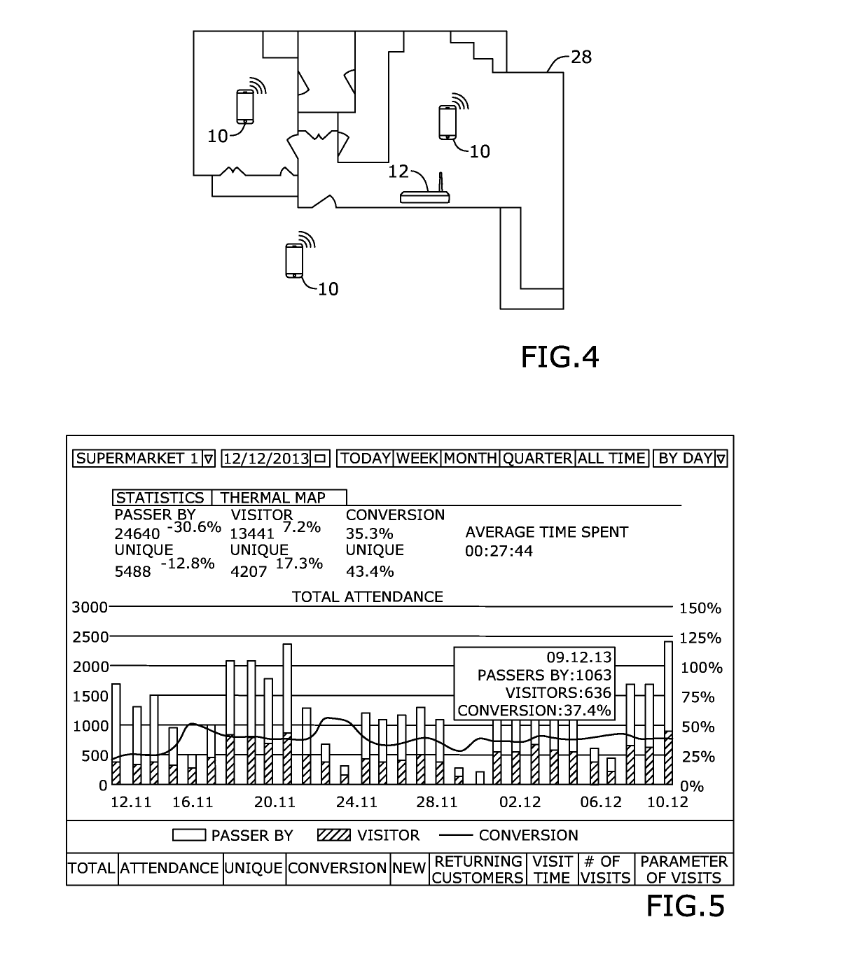

The routers 12 may be dispersed in different areas of the predetermined space—including but not limited to a retail store location—such that, as the consumer travels near the different areas, the wifi device 10 will communicate with different routers 12. The controller 14 can track information about which router each wifi device 10 communicated with and when. FIGS. 2, 3, and 4 are diagrams of the system installed in a supermarket, movie theater, and apartment, respectively. In the supermarket example of FIG. 2, the routers 12, each with an associated range of coverage 20, are spaced to cover almost the entire store, while having significant overlap. Using triangulation, the controller 14 can better understand its customer's location when they are in an area of router range overlap 30. Moreover the total time-span spent in each location by the wifi device 10 is recorded so that an approximate map of the customer's trip through the store can be generated. In the movie theater example of FIG. 3, the system can determine which theater the customer was in and when, enabling the theater owner or other interested parties to determine which movie the customer watched, and whether they bought concessions. In certain embodiments, the customer can be monitored to determine if they went to multiple movies. In the apartment example of FIG. 4, the system can be used to track visitors, residents, and passersby of an apartment within a complex.

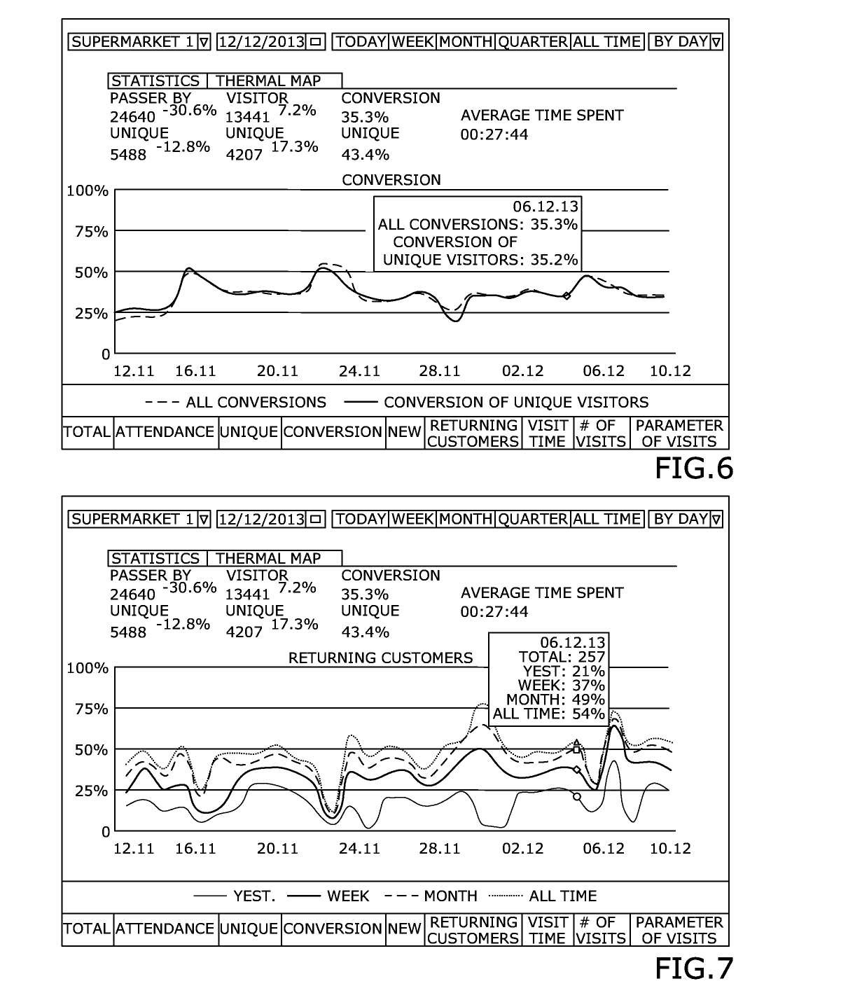

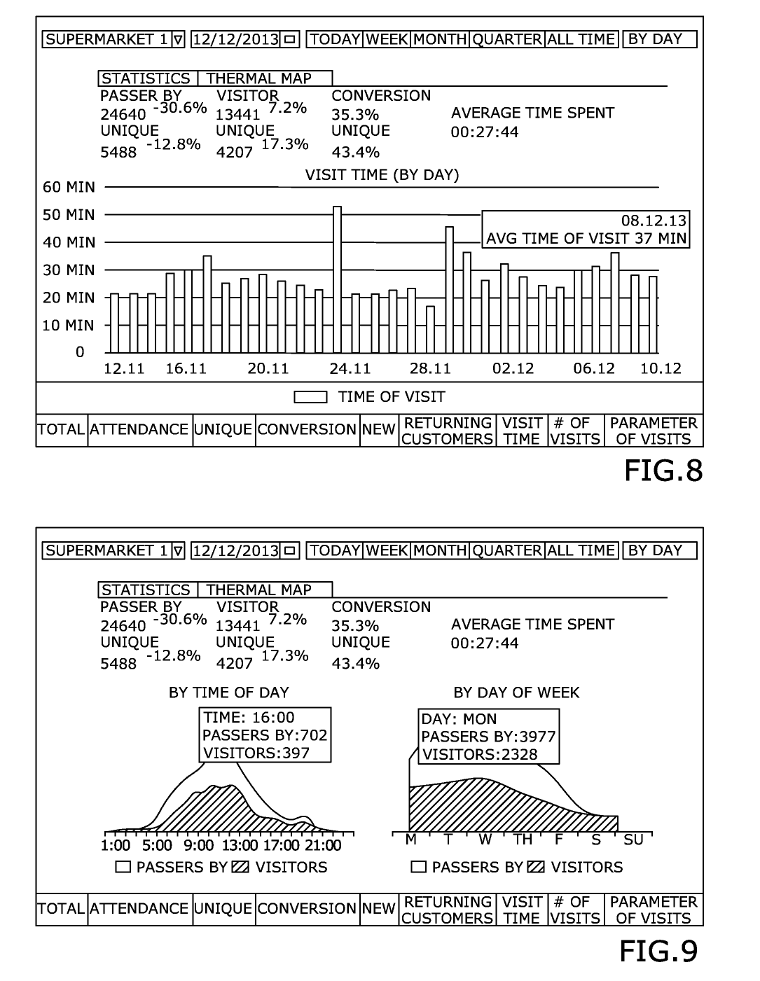

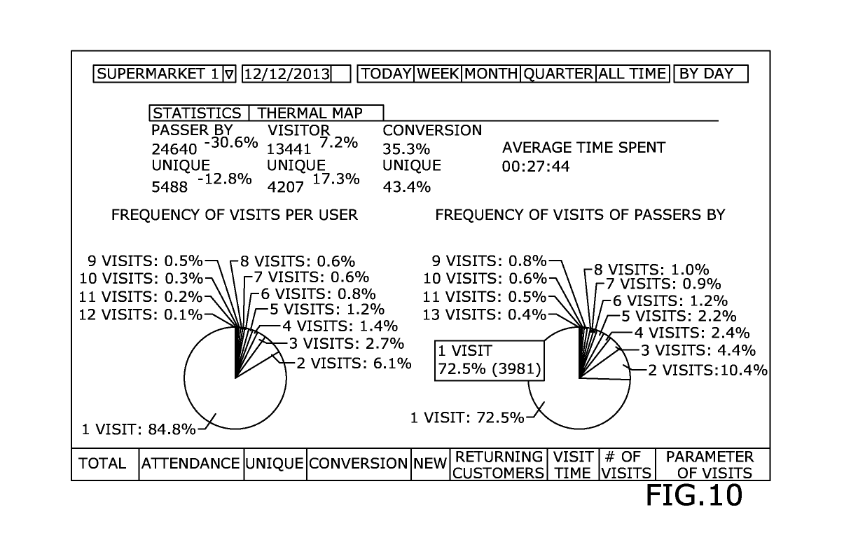

FIGS. 5-10 shown the data and analytics information the system can generate based in part on the collected customer information 18. As shown in FIGS. 5 and 6, the system can differentiate between a visitor, a customer, and a passerby, and thus determine its customer acquisition rate. As shown in FIG. 7, the system can also determine the rate of returning customers and perform analytics based on that information. As shown in FIGS. 8 and 9, the system can track the amount of foot traffic by time of day, and perform analytics based on that information. As shown in FIG. 10, the system can track the frequency of visits by visitors, customers, and passersby, and perform analytics based on that information.

As stated above, retail store owners have not been able to track their customers and efficiently market directly to them. The system described here solves this problem—by bringing the advance of digital tracking technology to brick and mortar locations. This wifi system is passive and collects data from the carrier's connection to the system of wifi units and not the individual's device. Using multiple routers in a store, smartphones can be tracked through the aisles, allowing the store owner to see where his/her customers spend time and allow him/her to market directly to his/her customers.

Although the invention has been described with reference to embodiments herein, those embodiments do not limit the invention. Modifications to those embodiments or other embodiments may fall within the scope of the invention.

The computer-based data processing system and method described above is for purposes of example only, and may be implemented in any type of computer system or programming or processing environment, or in a computer program, alone or in conjunction with hardware. The present invention may also be implemented in software stored on a computer-readable medium and executed as a computer program on a general purpose or special purpose computer. For clarity, only those aspects of the system germane to the invention are described, and product details well known in the art are omitted. For the same reason, the computer hardware is not described in further detail. It should thus be understood that the invention is not limited to any specific computer language, program, or computer. It is further contemplated that the present invention may be run on a stand-alone computer system, or may be run from a server computer system that can be accessed by a plurality of client computer systems interconnected over an intranet network, or that is accessible to clients over the Internet. In addition, many embodiments of the present invention have application to a wide range of industries. To the extent the present application discloses a system, the method implemented by that system, as well as software stored on a computer-readable medium and executed as a computer program to perform the method on a general purpose or special purpose computer, are within the scope of the present invention. Further, to the extent the present application discloses a method, a system of apparatuses configured to implement the method are within the scope of the present invention.

It should be understood, of course, that the foregoing relates to exemplary embodiments of the invention and that modifications may be made without departing from the spirit and scope of the invention as set forth in the following claims.

What is claimed is:

1. A system for tracking consumers in a predetermined space, comprising:
a controller;
at least one wifi router selectively positioned around the predetermined space, each wifi router in communication with said controller; and
at least one wifi device carried by a consumer,
wherein each wifi router is adapted to communicate with at least one wifi device, and
wherein the controller is configured to determine a route through the predetermined space taken by at least one wifi device from the identity of each router that communicated with at least one wifi device and the times of those communications.

2. The system for tracking consumers in a predetermined space of claim 1, wherein the controller is configured to generate a map of the route taken by each wifi device within the predetermined space.

3. The system for tracking consumers in a predetermined space of claim 2, wherein the map is weighted to indicate the timespan spent in each location along the route.

4. The system for tracking consumers in a predetermined space of claim 3, wherein the controller is configured to perform analytics on each weighted map so as to determine overall foot traffic and frequency of each customer's occupation within the predetermined space.

5. The system for tracking consumers in a predetermined space of claim 1, wherein each wifi router has an associated range of coverage that is overlapped with any adjacent wifi router.

6. The system for tracking consumers in a predetermined space of claim 1, wherein the controller is configured to collect consumer information associated with the wifi device,
whereby the consumer information is indicative of personal preferences of the customer carrying each wifi device.

7. A method of tracking consumers within a predetermined space, comprising:
providing a controller in communication to at least one wifi router;
selectively placing at least one wifi router throughout the predetermined space;
configuring at least one wifi router to passively communicate with at least one wifi device occupying the predetermined space, wherein each wifi device is carried by a consumer, and
configuring the controller to determine a route travelled and the time spent by each wifi device based in part on identifying each router that communicated with each wifi device and the times of those communications.
